(19) United States
(12) Patent Application Publication
(10) Pub. No.: US 2008/0263617 A1
(43) Pub. Date: Oct. 23, 2008

(54) Portable Media Player

(75) Inventors: Chun-Kai Chan, Taipei (TW); Fou-Ming Liou, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/106,430

(22) Filed: Apr. 21, 2008

(30) Foreign Application Priority Data
Apr. 20, 2007 (TW) 96114081

(51) Int. Cl. H04N 7/173

(52) U.S. Cl. 725/131

(57) ABSTRACT

A portable media player has a decoder, an encoder, and a wireless transmission module. The decoder is used to convert an audio and video signal into a video stream and an audio stream. The encoder is used to encode the video stream and the audio stream to an audio and video stream signal. The wireless transmission module is used to transmit the audio and video stream signal to a display device having a wireless signal receiver.

### RELATED APPLICATIONS

This application claims priority to Taiwan Application Serial Number 96114081, filed Apr. 20, 2007, which is herein incorporated by reference.

### BACKGROUND OF THE INVENTION

1. Field of the Invention

The invention relates to an audio and video device and, more particularly, to a portable media player (PMP).

2. Description of the Related Art

A portable media player (PMP) is a terminal device for providing audio and video program for users anytime. For example, audio and video fragments in a computer, analog television signal and digital television signal all may be played by a PMP. A common PMP is only equipped with a small built-in screen to avoid inconvenience caused by overlarge size in carriage. However, the too small screen limits the number of users who may enjoy the audio and video program played by the PMP at the same time.

Therefore, increasing the number of users who may enjoy the audio and video program played by the PMP at the same time thus to improve the function of the PMP is a wish of manufacturer and users.

### BRIEF SUMMARY OF THE INVENTION

The objective of the invention is to provide a portable media player (PMP) to increase the number of people enjoying the audio and video content played by the PMP at the same time.

According to the objective of the invention, a PMP is provided. The PMP has a decoder, an encoder and a wireless transmission module. The decoder is used for converting the audio and video signal to video stream and audio stream. The encoder is used to encode the video stream and audio stream to the audio and video stream signal. The wireless transmission module is used to transmit the audio and video stream signal to the display device having a wireless signal receiver.

The wireless transmission module is installed in the PMP, and it transmits the audio and video stream signal to the display device having the wireless signal receiver. The PMP may play content via the display device in a range of transmitting and receiving wireless signals, and then a plurality of users may enjoy the audio and video content at the same time.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing the whole system of the portable media player (PMP) of one embodiment of the invention;

FIG. 2 is a schematic diagram showing the whole system of the PMP of another embodiment of the invention;

FIG. 3 is a schematic diagram showing working state of the PMP of one embodiment of the invention; and

FIG. 4 is a schematic diagram showing another working state of the PMP of one embodiment of the invention.

### DETAILED DESCRIPTION OF THE EMBODIMENT

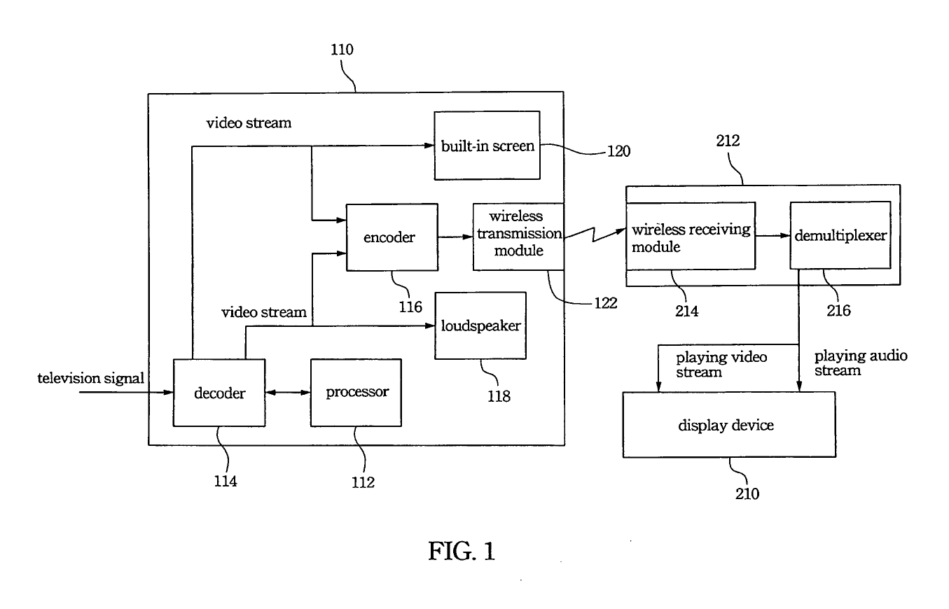

As shown in FIG. 1 which is a schematic diagram showing the whole system of the portable media player (PMP) 110 of the embodiment of the invention, the PMP 110 includes a decoder 114, an encoder 116 and a wireless transmission module 122. The decoder 114 is mainly used to convert the audio and video signal which the PMP 110 needs to play to video stream and audio stream. For example, the MPEG 2 audio and video signal is converted to MPEG 2 video stream and MPEF 2 audio stream after passing the decoder 114. The format of the audio and video signal is not limited in the invention, and other standards in the field such as MPEG 4 are also within the invention. The encoder 116 encodes the video stream and audio stream to the audio and video stream signal. Then, the audio and video stream signal is received by the wireless transmission module 122 and is transmitted to the display device 210 having the wireless signal receiver 212. Thus, the PMP 110 may transmit the audio and video signal which needs to be played in the form of wireless signal via the wireless transmission module 122.

In addition, the PMP 110 further includes a processor 112, a built-in screen 120 and a loudspeaker 118. The processor 112 is a main processing unit of the PMP 110 and is coupled to the decoder 114 to assist the decoder 114 in decoding. The built-in screen 120 and the loudspeaker 118 play the video stream signal and the audio stream signal, respectively. Thus, the PMP 110 also can play the audio and video signal.

After the content sent by the PMP 110 is transmitted in the form of wireless signal, the display device 210 having the wireless signal receiver 212 receives and displays the wireless signal. The wireless signal receiver 212 is provided with a wireless receiving module 214 and a demultiplexer 216 therein. The wireless receiving module 214 is used to receive the audio and video stream signal which is converted to wireless signal to transmit. The demultiplexer 216 converts the audio and video stream signal to the playing video stream and playing audio stream for the display device 210 coupled to the wireless signal receiver 212 to play.

The audio and video signal of the PMP 110 may be digital audio and video file, digital television signal or analog television signal stored in the PMP 110 at advance.

In another embodiment of the invention, the PMP 110 is suitable to transmit the multimedia stream signal to an external television display device such as the wireless signal receiver 212 and the display device 210. The PMP 110 includes a decoder 114, an encoder 116 and a wireless transmission module 112. The decoder 114 is used for converting the digital television signal to the video steam and audio stream. The encoder 116 is used for encoding the video stream and audio stream to an audio and video signal. The wireless transmission module 112 is used for transmitting the audio and video stream signal to the external television display device.

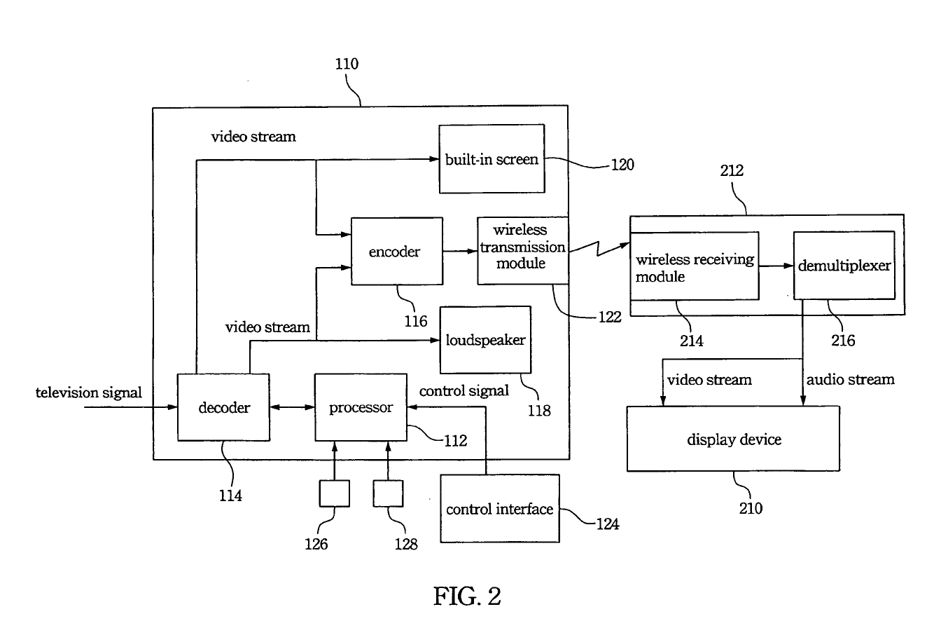

FIG. 2 is a schematic diagram showing the system of a PMP of another embodiment. The PMP 110 further includes a video signal input end 126 and an audio signal input end 128 which are coupled to the processor 112, respectively. Therefore, the decoded audio and video signals includes the signals inputted by the video signal input end 126 and the audio signal input end 128 besides the above kind of signal. In addition, the PMP 110 also has a control interface 124. The control interface 124 transmits a control signal to the processor 112 and selects the source of audio and video signal which needs to be decoded by the decoder 114 to transmit different audio and video stream signal to the display device via the wireless transmission module 122.

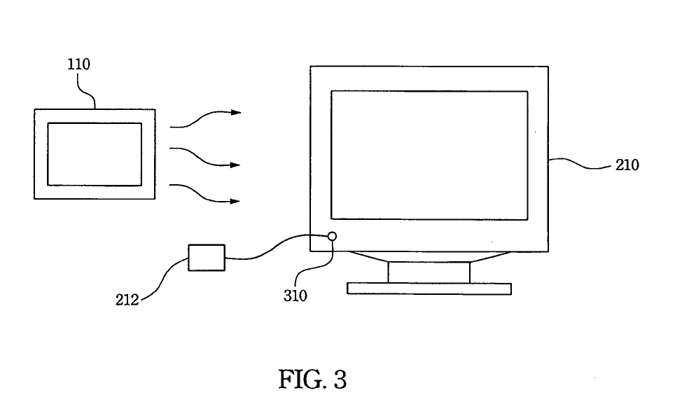

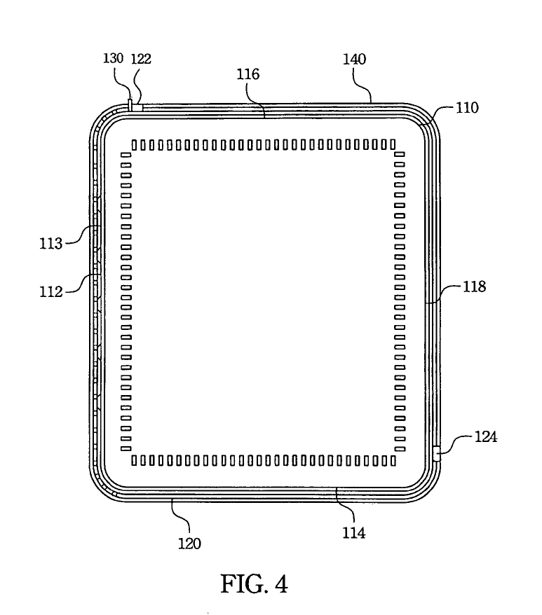

FIG. 3 is a schematic diagram showing the working state of the PMP 110 of the embodiment of the invention. FIG. 4 is a schematic diagram showing another working state of PMP 110 of the embodiment of the invention. The audio and video stream signal is transmitted by the PMP 110 in the form of wireless signal and is received and played by the display device 210 having the wireless signal receiver 212. The wireless signal receiver 212 may be connected to the display device 210 via the audio and video terminal 310, as shown in FIG. 3, or is integrated into the display device 210 directly, as shown in FIG. 4.

Compared with the common PMP which cannot transmit the audio and video signal played therein to a playing device with a large screen or only can be connected to a television by a signal wire, the PMP of the embodiment of the invention wirelessly transmits the audio and video signal played therein to a display device having a specific wireless signal receiver. Therefore, user gets rid of the fetter of the signal wire and may determine to transmit the audio and video signal to a playing device or not freely, which solves the problems that the built-in screen of the PMP is too small and does not have inconvenience caused by the limited length of the signal wire connected to the television. The used wireless transmission specification may be wireless communication protocol such as 802.11a, 802.11b, 802.11g or 802.11n. The kind of the communication protocol is selected according to signal transmission bandwidth and the signal transmission distance in the practical design.

In addition, when the PMP can receive and play television signal by itself, it can wirelessly transmit the play content to the display device having wireless signal receiver to receive and play. Then, the antenna disposition of the display device and cost of related decoding chip are decreased. Furthermore, the communication protocol between the PMP and the wireless signal receiver also may have special design to allow the audio and video content played by the PMP to be received by the wireless signal receiver in the form of broadcast. Then, one PMP may be corresponding to a plurality of display devices which may play the same content at the same time, and the application range of the PMP is expanded.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

1. A portable media player comprising:
a decoder for converting an audio and video signal to a video stream and an audio stream;
an encoder for encoding the video stream and the audio stream to an audio and video stream signal; and
a wireless transmission module for transmitting the audio and video stream signal to a display device having a wireless signal receiver.

2. The portable media player according to claim 1, wherein the wireless signal receiver has a wireless receiving module and a demultiplexer, the wireless receiving module is used for receiving the audio and video stream signal, and the demultiplexer is used for converting the audio and video stream signal to a playing video stream and a playing audio stream for the display device to display.

3. The portable media player according to claim 1, wherein the audio signal is a digital audio and video file stored in the portable media player in advance.

4. The portable media player according to claim 1, wherein the audio and video signal is a digital television signal.

5. The portable media player according to claim 1, wherein the audio and video signal is an analog television signal.

6. The portable media player according to claim 1, further comprising a video signal input end and an audio signal input end.

7. The portable media player according to claim 6, wherein the audio and video signal is the signal inputted by the video signal input end and the audio signal input end.

8. The portable media player according to claim 1, wherein the wireless signal receiver is integrated into the display device.

9. The portable media player according to claim 1, wherein the wireless signal receiver is connected to the display device via an audio and video terminal.

10. A portable media player which is suitable to transmit a media stream signal to an external television display device, the portable media player comprising:
a decoder for converting a digital television signal to a video stream and an audio stream;
an encoder for encoding the video stream and the audio stream to an audio and video stream signal; and
a wireless transmission module for transmitting the audio and video stream signal to the external television display device.
